(19) United States
(12) Patent Application Publication
(10) Pub. No.: US 2005/0140237 A1
(43) Pub. Date: Jun. 30, 2005

(54) Rotary motion

(76) Inventors: Nicholas Souris, Smyrna, GA (US); Francis James Souris, Smyrna, GA (US); Patrick Allen Souris, Smyrna, GA (US)

Correspondence Address: NICHOLAS SOURIS, 331 HURT ROAD SW, SMYRNA, GA, 30082, US

(21) Appl. No.: 10/746,680

(22) Filed: Dec. 29, 2003

(51) Int. Cl. H02K 7/02; H02K 17/00; H02P 3/08

(52) U.S. Cl. 310/166; 310/168; 318/254; 310/74; 310/261

(57) ABSTRACT

This invention relates to an electric motor design, which uses the design introduced in U.S. Pat. No. 6,060,798 entitled “Straight Motion” issued May 2000, with certain improved variations. More particularly instead of having the plungers set on a straight line, this invention pertains to setting the plungers in a circular position of a fixed diameter and also have the coils set in the same circular arrangement, aligned properly to each other, so coils and plungers can interact accordingly when energized. Now if each plunger is supported by a bracket connected to a common shaft located in the center of said circle. Said bracket being of a size and shape able to travel through the slot provided in the magnetic coils used. When each coil is energized it will pull a plunger into the magnetic field and thus force the shaft to rotate, thus causing a rotary motion, provided that the coils and plungers are set in certain desirable spacing in relation to each other for the purpose of this application. If the coils are energized continuously and in certain sequence, said rotary motion will continue, thus producing a perpetual rotary motion. In this case, the coils will be set in a fixed position and the plungers will be all connected to the same shaft. When the coils are energized in certain sequence, the energized coil will pull a plunger into the coil's magnetic field, causing a rotary motion along the shaft, and the energy produced in the shaft can be used accordingly. This creates a device similar to an electric motor or a variation thereof. The main advantage in this device is that the bracket of each plunger is acting as a lever, thus the force produced by the coil is transmitted to the shaft, through the bracket first and second class lever theories, therefore the length of the bracket will further enhance the energy so produced by the magnetic coils, thus increasing the energy output transferred to the shaft.

### FIELD OF THE INVENTION

This invention relates to an electric rotary motion design, which uses the design introduced in U.S. Pat. No. 6,060,798 entitled “Straight Motion” issued May 2000, inventor: Nicholas Souris, with certain variations and improvements.

“Straight Motion” abstract is herein summarized:

“Straight Motion is a method of winding an electromagnetic coil creating a slot on the side of the coil, allowing a space for the plunger support to slide through the coil. Such an arrangement will permit the plunger to be permanently mounted, and allow the coil to travel over the plunger and past it in either direction.

Thus, by installing a series of plungers and their supports aligned in a straight line, said coils can be moved over the plunger or plungers by sequential energization and thus create a linear motion or otherwise referred here as Straight Motion.”

More particularly instead of having the plungers installed on a straight line, this invention pertains to setting the plungers in a circular position of a fixed diameter and thus have the coils set in the same circular position, aligned properly to each other, so coils and plungers can interact accordingly when energized. As an option the shape of the plungers and coils could also have a curvature similar to the circular design of the perimeter so it will facilitate the rotation.

Each plunger is supported by a bracket connected to a common shaft located in the center of said circle. Said bracket is able to travel through the slot provided in the magnetic coils. When each coil is energized it will pull the plunger into its magnetic field and force the shaft to rotate, creating a rotary motion. Consequently if the coils are energized continuously and in certain sequence, said rotary motion will continue.

In this case, the coils will be set in a fixed position and all the plungers will be connected to the same shaft, and when the coil(s) are energized in said sequence, they will pull the plunger(s) into the coil's magnetic field, causing a circular rotation along the shaft, and the created energy along the shaft can be used accordingly. This creates a device similar to an electric motor or a variation thereof.

The main advantage in this device is that the bracket of each plunger is acting as a lever. The force produced by the magnetic coil is transmitted to the shaft, through the “lever class 1 and 2” theories, thus increasing the energy output transferred to the shaft. Said energy is relative to the length of the bracket, based on the ratio of the “load arm” and “power arm” of the lever class 1 and 2 so created.

When the length of the bracket is increased, so is the energy output increased along the shaft.

This device can be categorized as an electric motor having certain advantages.
1 Compared to an electric motor, it will produce more energy for the same input of power.
2 By installing more sets of coils, the output of the motor can be varied easily by switching on or off certain sets of coils.
3 Speed will be controlled by the frequency applied on the operating voltage.
4 This design can be further improved by replacing the brackets holding the plunger by a disc, the plungers are supported on the periphery of the disc and at the center of the disc the shaft will be located. Said shaft will be supported by at least two bearings, thus allowing it to rotate and maintain its position.

### OBJECT OF THE INVENTION

The primary object of this invention is to convert the use of straight motion energy as described in U.S. Pat. No. 6,060,798 entitled “Straight Motion” issued May 2000, to a “rotary motion” energy, thus rendering its use much simpler in certain circumstances and becoming also a form of an electric motor with added advantages.

For example, in the case of an electric train being powered by a straight row of plungers, added along the rail tracks, it becomes a costly installation. This can be replaced by using a number of circular units as described above, coupled to the train wheels, to produce said energy requirements.

### SUMMARY OF THE INVENTION

The introduction of the coil design described in the “straight motion” U.S. Pat. No. 6,060,798, installed in a circular pattern, will allow a variation in the manufacturing of an electric motor with added advantages compared to the existing ones.

This design will permit the creation and manufacture of an electric motor variation that can prove more efficient and practical to use with A.C. or interrupted D.C. power.

The frequency (hertz) of A.C. power, will determine the speed of said motor device.

In D.C. power, energizing the coils, as an example could be the use of a device similar to a car distributor type, where the distributor rotor transfers power to the coils through the distributor cap in a pre-set sequence. The speed of the distributor rotor will control the firing speed of the coils and thus establish the speed of said circular motion motor.

Simple means to change the energy output of the motor by energizing on or off additional sets of coils.

### MODE OF OPERATION

Referring to U.S. Pat. No. 6,060,798 entitled “Straight Motion” issued May 2000, which is a design that creates a straight motion, by installing said plungers in a straight line, and the coils will travel over said plungers and create a straight motion. Such arrangement limits the use of this application, as the cost becomes a considerable factor.

Therefore by installing said plungers in a circular position of a fixed diameter and also having the coils set in the same circular position, aligned properly to each other, so they can interact accordingly when energized. And having an option, in this case it might prove more efficient to have the coils installed stationary and the plungers movable.

Each plunger is supported by a bracket connected to a common shaft located in the center of said circle. Said bracket is able to travel through the slot provided in the magnetic coils used.

When each coil is energized, it will pull the plunger into the magnetic field and thus force the shaft to rotate, causing a rotary motion. If the coils are energized continuously and in certain sequence, said rotary motion will continue, thus producing a perpetual rotary energy.

In this case, the coils will be set in a fixed position and the plungers will all be connected to the same shaft, thus, when the coils are energized it will pull the plungers into the coils magnetic field, which causes a rotary motion along the shaft.

The spacing, the position and the number of coils and plungers will determine various obtainable results.

This creates a device similar to an electric motor or a variation thereof.

### THE DRAWINGS

The invention, both as to its arrangement and mode of operation, can be more fully understood from the following exposition, when it is considered in conjunction with the accompanying drawings in which:

FIG. 1 shows a graphic representation of the lever theory class 1 and 2 applied here.

FIG. 2 shows a graphic representation of the design in FIG. 4, however the plungers and coils are set in circular pattern, with a common shaft supporting said plungers, and as an option, in this case that might prove beneficial, the coils are being stationary and the plungers are allowed to move in and out of the coils and thus transferring said energy to the common supporting shaft.

FIG. 3 shows the same arrangement as FIG. 2 but instead of the plungers being connected via individual brackets and then to the shaft, the brackets are being replaced by a disc and at the center of the disc the shaft is connected. This arrangement offers more overall strength and becomes a simpler design in manufacturing.

FIG. 4 shows a graphic representation of the design as represented in the patent previously recorded U.S. Pat. No. 6,060,798 entitled “Straight Motion” issued May 2000.

FIG. 5 shows a graphic representation of the plungers and coils and their respective position when energized with D.C. Power, switched on and off, in a certain sequence, in order to accomplish the results needed.

### DESCRIPTION OF THE PREFERRED EMBODIMENTS

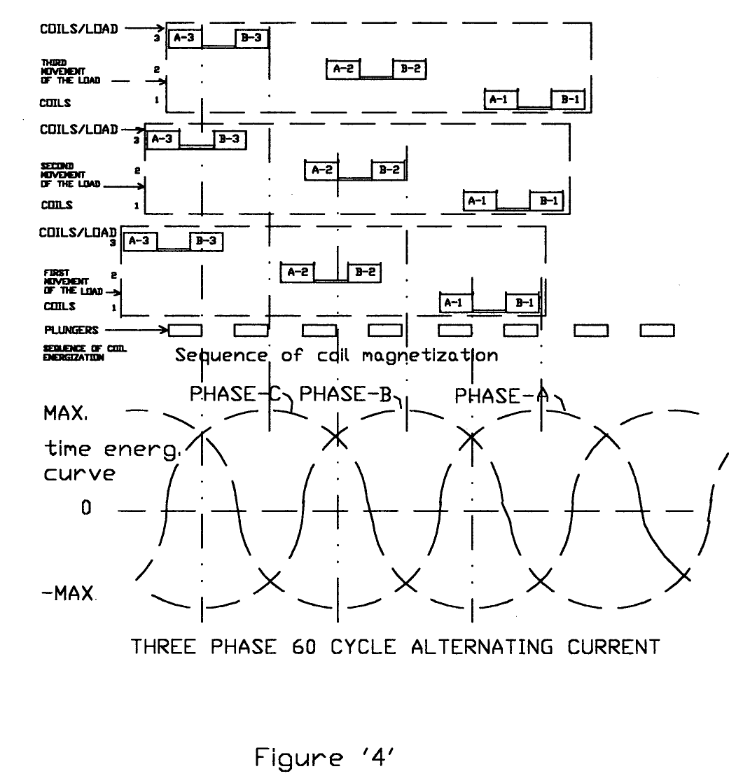

This submitted patent refers to the drawings in which a preferred embodiment of the invention is illustrated in FIG. 4, a copy herewith included from the previous U.S. Pat. No. 6,060,798 entitled “Straight Motion”, showing the plungers and coils being arranged in a straight line, thus producing a straight motion. Said coils being energized in a certain sequence, as illustrated in the drawing, will move along the plungers and thus produce a straight motion.

FIG. 4 shows an example with three “sets of two coils” labeled A-1 & B-1, A-2 & B-2, A-3 & B-3. All these coils are mounted on the same load to be carried by the electromagnetic forces to be produced. Said set of coils are energized in sequence 1 through 3, each set to move the load two thirds (⅔) the length of the plunger distance. In this case, the distance between the plungers is the same as the length of the plungers and coils, and it is referred here as the “unit distance”. The spacing between the coils from each other is one and third (1&⅓) the unit distance.

The first line represents the set of coils A-1 & B-1 being energized first, the second line represents the set of coils A-2 & B-2 being energized second and the third line represents the set of coils A-3 & B-3 being energized third. In each case, FIG. 4 shows the relative position of all the coils in reference to the plungers. It is important that the plunger to be energized next should be partially in the coil, so when the coil is magnetized it will pull the rest of the plunger in. The sizes and spacing used here are an example in order to clarify the functions involved. And again in this case, provided that one third (⅓) of the plunger is in the coil to be energized next, each set of coils will move two thirds (⅔) the unit distance referred herein, which is the same length as the plunger. The same function can be repeated over and over again by means of switching said sets of coils and at this specific sequence, creating a perpetual linear movement of the load connected to theses three sets of coils. The speed of the movement will depend on the frequency and sequence of switching these three sets of coils and energy will depend on the length and the size of the coils, the plungers and other factors.

A three phase 60 cycle alternating current could provide such power to the above listed three sets of two coils with each electrical power phase connected respectively to each set of two coils and thus, when each set is energized, will create such motion as described above.

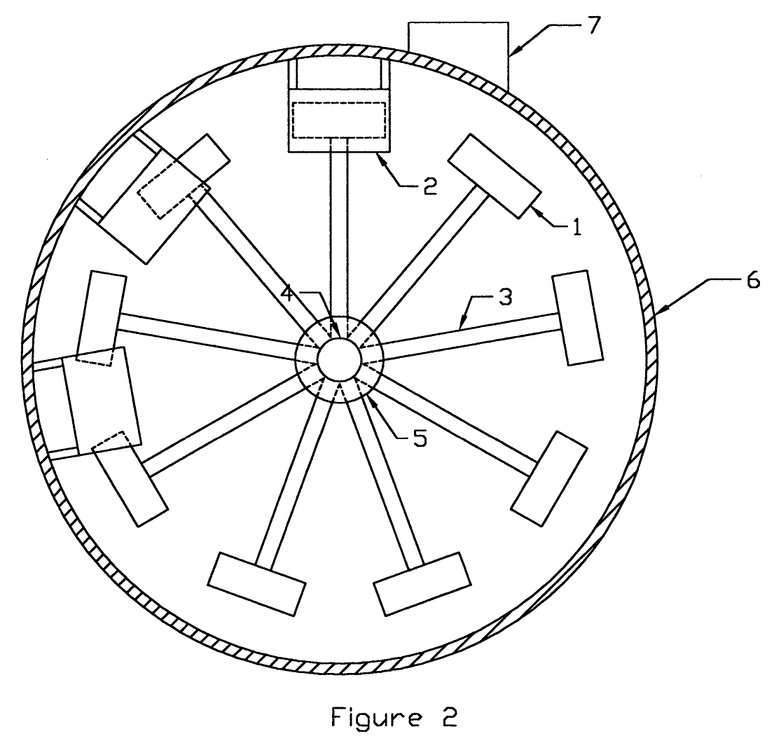

FIG. 2 shows the same arrangement applied in U.S. Pat. No. 6,060,798 entitled “Straight Motion” issued May 2000 and briefly described above and in conjunction with the drawing in FIG. 4. However, in this case the plungers and the coils are set in a circular pattern and the plungers having their supports connected to a common shaft, which produces a rotary motion. In this case the plungers are movable and the coils are stationary.

FIG. 2 shows also side and sectional views.
1 Represents a plunger.
2 Represents a coil with a slot in order to allow the plunger support to slide through the coil.
3 Represents the plunger support designed to slide through said coil #2 and said plunger support being connected to the shaft #4 and said shaft being common for all the supports.
4 Represents the shaft.
5 Represents the bearings at least two, supporting shaft #4.
6 Represents the housing of the device described above.
7 Represents provision to connect electrical power.

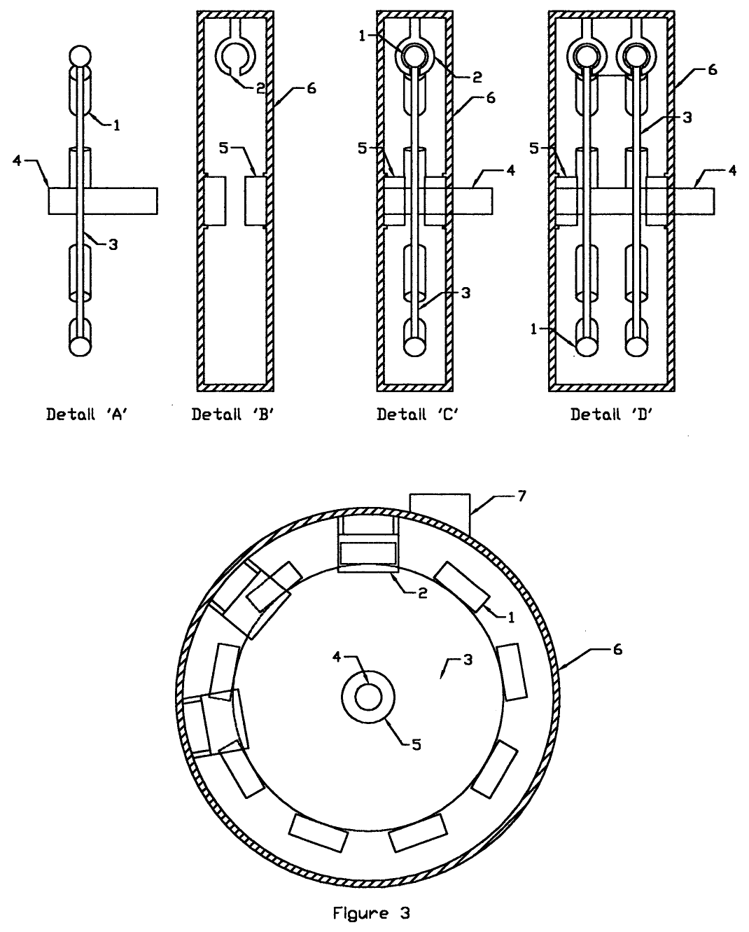

FIG. 3 shows side and sectional details same as in FIG. 2, however the individual brackets are replaced by a disc, supporting all the plungers and the common shaft.
1 Represents a plunger.
2 Represents a coil with a slot.
3 Represents the plunger support being replaced in this case by a disc, capable to slide through coil #2.
4 Represents the shaft and said shaft being supported and secured to rotate within the bearings #5.
5 Represents the bearings, at least two.
6 Represents the housing of the device.
7 Represents provision to connect electrical power.

The coils #2, bearings #5 and electrical connections #7, being supported permanently within a frame structure #6, referred here as part one of this device, shown in detail “B”.

The shaft #4, the disc #3 and the plungers #1, referred herein as part two, as shown in detail “A”.

Part two is supported through the bearings #5 shown on “part one” and shown in detail “C”. Thus part one can rotate within the bearings by the electromotive force produced when the set of coils are energized.

This design could be characterized as an electric motor of a slimmer shape and of a larger diameter, with optional electrical means for switching additional sets of coils in order to accomplish power output variations, such as starting speed, running speed, power output and other factors.

In addition, since a set of coils consist of two coils, a second similar disc can be introduced and be energized by the second coil, thus using the energy so far applied to its maximum potential. This is shown graphically in detail “D”.

Starting speed can be accomplished by a set of coils and plungers of different sizes and spacing than the running speed requirements and can be electrically switched separately.

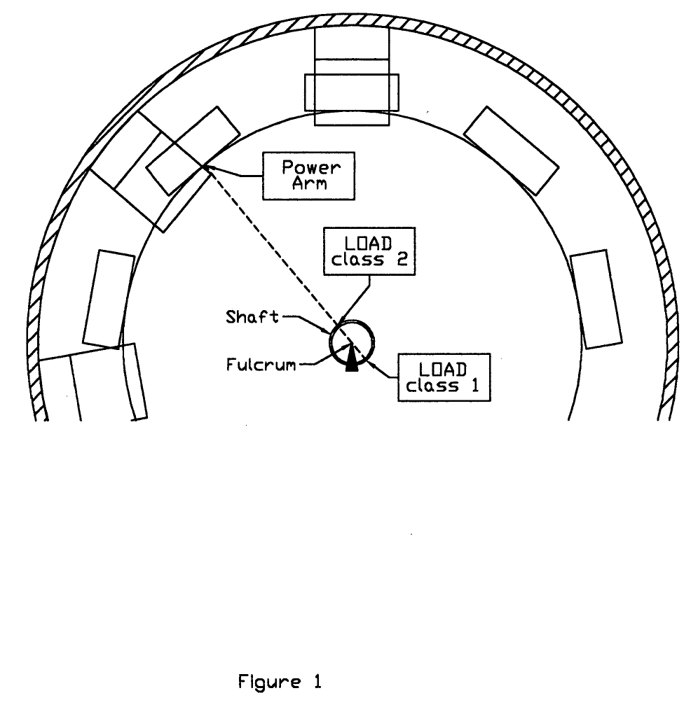

FIG. 1 illustrates the theories of lever class 1 and 2.
a. Represents the center of the shaft being the fulcrum of the lever.
b. Represents the radius of the shaft which is the load distance from the fulcrum, establishing the “load arm”.
c. Represents the length of the plunger support from the plunger to the center of the shaft, establishing the “power arm”.

The ratio of the “power arm” and the “load arm” determines the multiplier of the power applied under “lever class 1 and class 2” theories.

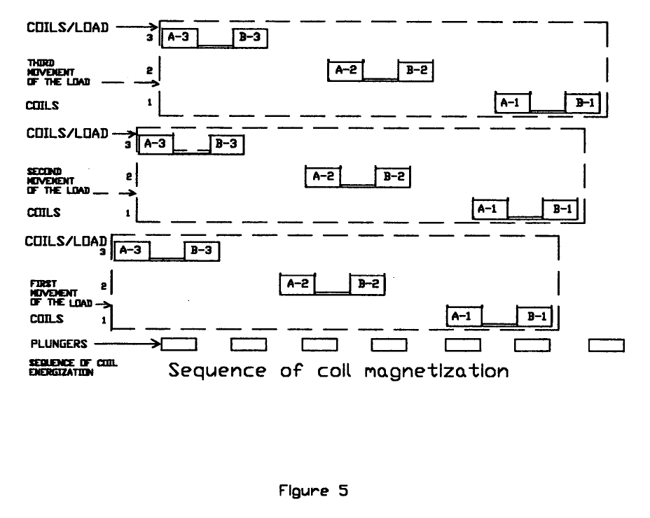

FIG. 5 shows a graphic representation of the plungers and coils and their respective position when energized with D.C. Power. When switching the coils “on and off” in certain sequence, a specific goal can be accomplished. The arrangement is very similar to what is shown in FIG. 4 which is powered with a three phase, 60 cycle alternating current.

In this case as an example, the D.C. power is interrupted by means similar to a car distributor where the distributor rotor fires D.C. power to the coils maintaining a set sequence.

And the speed of the distributor rotor will control the speed of the rotary energy so produced by means of this motor design.

Simple means to change the energy output of the motor by energizing on or off additional sets of coils.

Conclusion, Ramifications and Scope

This invention provides means to use an existing patent entitled “Straight Motion” producing straight or linear motion and in this case being converted to a “Rotary Motion, thus becoming more practical for its use in some instances and therefore more exploitable.

In so doing and as compared to the known electric motor designs, certain advantages are obtainable:
1 Higher energy output is obtained for the same input due to the lever class 1 and 2 theories effect, because the plungers are attached to the shaft by a bracket of a certain length.
2 More than one set of magnetic coils can be installed and said additional coils can have means to be switched ‘on or off’, thus varying the energy and speed output.
3 Speed can be controlled by the applied frequency, which in turn controls the switching of the coils, according to the sequence of switching of said sets of coils.

Environmental Impact: The environment stands to benefit since energy is produced without causing harm to the environment.

Efficiency: The use of straight motion as described in U.S. Pat. No. 6,060,798 entitled “Straight Motion” issued May 2000, is introduced in a simpler form, making it comparable to an electric motor and thus becoming more suitable to use in more applications.

Conclusion: A positive improvement towards electric motor production and use.

Reliability: The design and manufacturing of said device is simple and therefore reliable.

Economics: Power output is increased for the same amount of energy input used with present devices.

1. An electrical device, characterized as a variation of an electric motor, producing rotary energy consisting of,
a sets of magnetic coils as designed in U.S. Pat. No. 6,060,798, entitled “Straight Motion”, issued May 2000, installed in the shell of said device, in a circular pattern of a set radius,
b a set of plungers as designed in U.S. Pat. No. 6,060,798, entitled “Straight Motion”, issued May 2000, installed in a similar circular pattern of a set radius and aligned with said magnetic coils installed on the shell of the device, so they can be pulled into the magnetic field of the coils,
c said plungers are supported each by a bracket connected to a common shaft located in the center of said circle, and being able to travel through the slot provided in the winding of the sets of coils, thus being able to move to the next coils and so on,
d said shaft being secured by at least two bearings, thus permitted to rotate within the bearings and transfer the energy so produced,
e means to furnish said device with electric power of a certain frequency, thus causing the on and off magnetization of the sets of coils in a certain sequence, which in turn will pull the plungers into their magnetic field and thus create energy.

2. A design as described in claim one, wherein said brackets being replaced by a disc, thus installing the plungers along the periphery of said disc and also have the shaft in the center of the disc supported by the bearings, thus permitted to rotate and maintain its position, said disc being able to travel through the slot space provided on the sets of coils.

3. A design as described in claim one, wherein said coils being energized by alternating current or direct current of a certain frequency.

4. A design as described in claim one, wherein a sets of coils and plungers, of a certain configuration, are used during the starting process allowing the disc to rotate at a lower speed and then switch to another set of coils and plungers, of different configuration, increasing to a running speed condition.

5. A design as described in claim one, wherein additional set of coils can be switched on and off in order to increase or decrease the power output as needed.

6. A design as described in claim one, wherein a second disc is added on the same shaft similar to the other and a set of plungers added, said plungers being pulled by the second coil of the sets of two coils used in this device, thus maximizing the use of power applied in this operation.

7. A design as described in claim one, wherein said frequency will control the speed of the shaft rotation.

8. A design as described in claim one, wherein the length of the plunger support bracket, becomes a considerable factor on the additional energy produced, due to the lever class 1 and class 2 theories, said factor depends on the ratio between the ‘power arm’ and the ‘load arm’, and said factor becomes the multiplier to the electromotive force produced by the coil being energized and pulling the plunger in.

9. A design as described in claim 1, wherein additional coils and plungers can be installed in said device, that can be switched independently, causing different motions as might be needed.

10. A design as described in claim 1, wherein the plungers and the coils are positioned in certain distances between each other in order to have a portion of the plunger into the coil to be energized next, thus said plunger will be pulled in all the way, once the coil is energized, and said movement of the plungers will set another plunger in a similar position in the coil to be energized next, and so forth, in order to have a continuous motion.

11. A design as described in claim one, wherein the plungers, as an example in order to demonstrate their use, are spaced at a distance between each other equal to the plunger's length and three sets of two coils are used and they are positioned in such a manner in reference to the plungers, so a portion of the plunger and in this case to illustrate an example a third (⅓) is in the coil referred here as the first coil, when the coil is energized, it will pull said plunger totally in the coil, said movement will set another plunger a third (⅓) in the second coil to be energized and so when this coils is energized it will pull the plunger totally in that coil and it will place another plunger a third (⅓) in the third coil to be energized, thus again when the third coil is energized under that sequence of power switching it will pull the plunger totally in the third coil, said movement will set another plunger a third (⅓) in the first coil, thus the sequence of operation is repeated over again, producing a continuous rotation, provided the coils are energized in that same sequence.

12. A design as described in claim 11, wherein a three phase 60 cycle alternating current could provide such power to the above listed three sets of two coils with each electrical power phase+connected respectively to each set of two coils and thus, when energized, will create such motion as described above.

13. A design as described in claim 11, wherein this design will permit the creation and manufacture of an electric motor variation that can use D.C. power, energizing the coils, by means of, as an example, a device similar to a car distributor, where the distributor rotor transfers power to the coils through the distributor cap poles in a pre-set sequence, and the speed of the distributor rotor will also control the firing speed of the coils and thus establish the speed of said circular motor motion.
